(19) United States
(12) Patent Application Publication
(10) Pub. No.: US 2016/0042150 A1
(43) Pub. Date: Feb. 11, 2016

(54) Intelligent Pill Dispenser With Remote Scheduling And Monitoring

(71) Applicant: Joseph Moloughney, Pompton Plaines, NJ (US)

(72) Inventor: Joseph Moloughney, Pompton Plaines, NJ (US)

(21) Appl. No.: 14/456,172

(22) Filed: Aug. 11, 2014

(51) Int. Cl. G06F 19/00; A61J 7/02; B65D 83/04; A61J 7/04

(52) U.S. Cl. CPC G06F 19/3462; A61J 7/0481; A61J 7/02; B65D 83/0409; B65D 2585/56; B65D 2590/0083

(57) ABSTRACT

A system for and method of locally and remotely controlling and monitoring medication dispensing process comprises a medication dispensing device which has a plurality of medication storage containers each of which configured to store one medication therein; a dispensing cup; and a plurality of physical control mechanism to warrant the dose is correctly dispensed and sending alerts to the remote app; and a remote app or web page that allows an end user or a remote caregiver to create and change a dose per medication as well as a schedule for each medication dose, provides alerts and notifications, stores history of doses delivered and doses removed from the dispensing cup, and submits automatic refill requests when storage containers approach refill levels;

### BACKGROUND OF THE INVENTION

1. Field of the Invention

This invention relates generally to medical field, and more particularly to medical pill dispensing system.

2. Description of Related Art

The present invention is intended to reduce complications of non-adherence to dose regiments of long term maintenance medication. Non-adherence to proper dosing results in hundreds of billions of dollars of cost in the US alone due to hospitalization, further complications of underlying conditions, and overdose, etc.

Over 30% of individuals age 57 and older in the US take 5 or more prescription medications daily. As the population ages, this number will continue to grow.

As people age it becomes more difficult to adhere to dosing regimens due to memory loss, deterioration of eyesight, deterioration of dexterity, etc.

Medication dispensing system to receive, store, track and/or dispense one or more pills for a user are known in the prior art. More specifically, by way of example, U.S. PreGrant Publication No. 20100076595 to Nguyen discloses a smart pill dispenser used to receive, store, track and/or dispense one or more pills for a user. The dispenser may be capable of tracking information related to the pills. Moreover, the user may manually enter their prescription details or alternatively, the dispenser may include a reader capable of reading the specific code and retrieving the details. The dispenser may be capable of informing the user when to take their pills. The dispenser may either automatically or manually quantify the pills in the dispenser.

U.S. PreGrant Publication No. 20090281657 to Gak discloses a medication reminder and dispensing system including a computing or electronic device for programming a medication regimen, such as a prescription, such as a prescription, a docking station or unit for downloading the medication regimen and storing a personal medicine container for holding a daily or weekly supply of the medication and receiving the medication regimen. The personal medicine container is carried by a user and includes an alarm for reminding the user to take or administer the medicine in accordance with the medication regime.

WO 2012163710 to Schilling Harry discloses a medication dispensing apparatus comprising a housing and an integrated docking unit for accommodating a plurality of medication cartridge. Each medication cartridge has at least one container wheel with a plurality of sealed compartments for holding medication. The medication from the cartridge is transported by a transport unit to a dispensing duct from which it may be received by a patient.

U.S. Pat. No. 5,907,493 to Boyer discloses a pharmaceutical dispensing system including a plurality of standardized or universal-type cells disposed in a large array called module. One or more modules may be disposed in a given pharmacy, and one or more pharmacies may be monitored by a central computer.

U.S. Pat. No. 5,884,806 to Boyer et al. discloses a pill-dispensing system which has a number of standardized, or universal-type module.

Each module has a rotating, helix-drive mechanism, which is rotationally controlled by a microprocessor. The helical-drive mechanism features several improvements, both in the drive mechanism and in the software control of the rotational drive system by the microprocessor that allows for the dispensing of pills of all shapes and sizes one at a time.

U.S. Pat. No. 8,590,737 to Clark et al. discloses apparatus and process for the automated, singulated dispensing of articles. The apparatus is a canister which houses a screw having a channel of a certain width and depth that corresponds to the dimensions of a particular type.

U.S. Pat. No. 8,009,040 to Kennedy discloses a medication dispensing system including a medication hopper, a dispensing mechanism that is configured that dispenses medicine from the hopper to a user and a processor. The processor is in communication with a communication network and is configured to generate instructions to the dispensing mechanism that cause the dispensing mechanism to dispense medications according to stored prescription and track an amount of medication in the medication hopper. If the amount is less than a predetermined threshold, then the processor is configured to send a message to a designated entity indicating that the amount of medication in the hopper is less than the threshold.

U.S. Pat. No. 7,624,894 to Gerold et al. discloses a pill-dispensing apparatus for automatically dispensing solid pills includes a plurality of storage units and a pill dispensing module. The store units store pills in bulk and each include a hopper and an auger movably positioned with respect to the hopper.

U.S. Pat. No. 5,042,685 to Moulding et al. discloses a dispensing having a compartment for detecting and counting the dispense objects especially adapted for dispensing medication and method of using the same.

### SUMMARY OF THE INVENTION

In general the device will be similar in size to a Keureg coffee maker. Will be modular in the sense that additional medication storage containers can be purchased and added to the device as needed.

Pills, tablets, capsules, caplets, gelcaps of any size or shape will be accommodated without the need for interchanging parts or components of the device. This is a key feature of the device. The ability to deliver the correct dose at the scheduled interval regardless of pill shape of size.

There will be a remote app so that the end user or a remote caregiver can both create and change the dose per medication as well as the schedule for each medication dose.

The app will also provide alerts, notifications and store history of doses delivered and doses removed from the dispensing cup, when storage containers approach refill levels.

Controls are built in to eliminate risk of miss-dosing.

The first control is a pill counting function utilizing a sensor which will count the pills dispensed by each storage container at each scheduled dose interval.

The second control is a weighing mechanism that will weigh the total dispensed dose at each dose interval and compare to that interval's correct dose weight.

If either of these controls indicates a miss-dose the medication will be routed to a secure storage area, alerts will be sent and a new dose will be dispensed.

Other features will include battery backup, manual dose dispensing (for vacations, etc.), in home local alert mechanisms such as worn pendants or table top alarms, automated refills.

Part of the offering is a subscription based service which includes:

1) Cloud hosted database with:

a. Prescription information, number of refills, filling pharmacy, prescribing doctors, etc.

b. Automatic refill requests integrated with pharmacy systems or manually requested by remote monitoring pharmacists

2) Remote monitoring service and in home visiting service by licensed pharmacists.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows main components of the medication dispensing system of the present invention which will be further elaborated later.

FIG. 2 is a block diagram showing a medication dispensing process utilizing the medication dispensing device.

FIG. 3 is a 3D drawing of the main components of a device of the present invention.

FIG. 4 is a list of features and commands for the remote app.

### DESCRIPTION OF THE PREFERRED EMBODIMENT

The present invention is a system 1 comprising a medication dispensing device which can be locally managed by an end user and remotely managed by the end user and remote caregivers. The medication described herein includes but is not limited to pills, tablets, capsules, gelcaps, caplets, etc. For simplicity, sometimes “pills” is used to represent the group of medication.

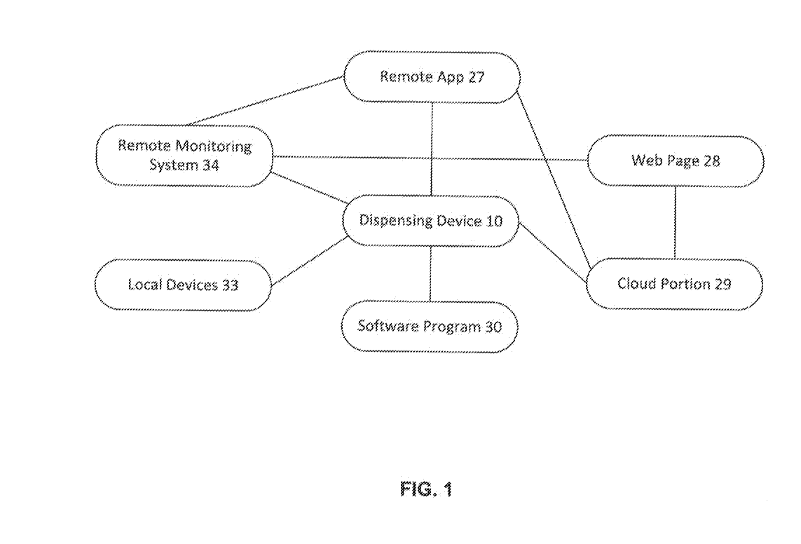

FIG. 1 shows main components of the medication dispensing system 1 of the present invention which will be further elaborated later.

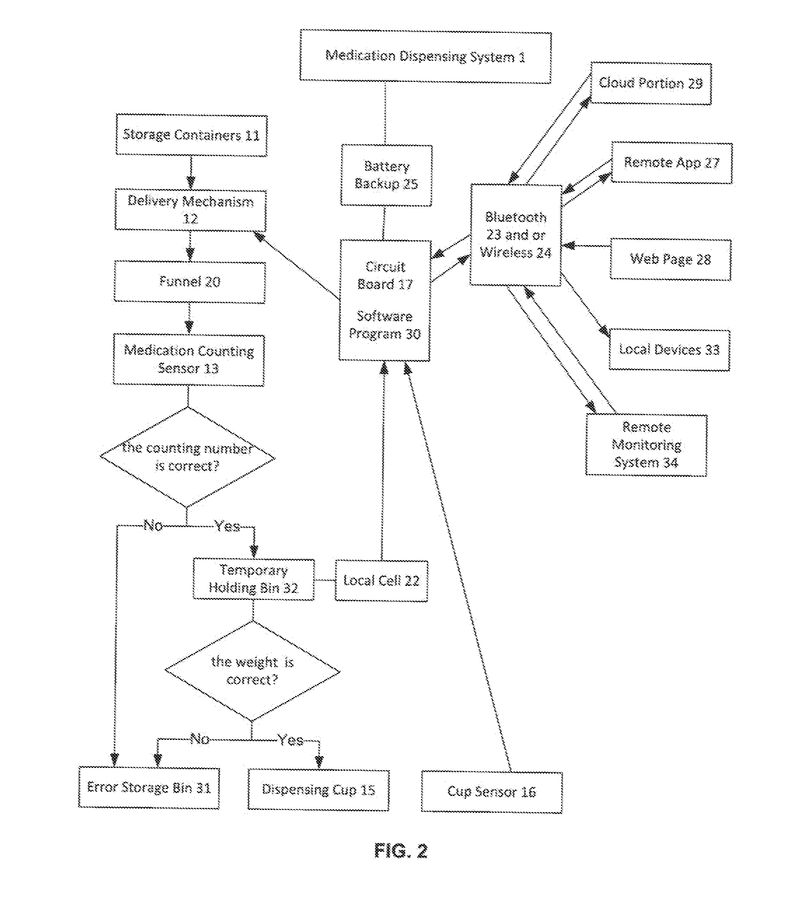

FIG. 2 is a block diagram showing a medication dispensing process utilizing the medication dispensing device 10.

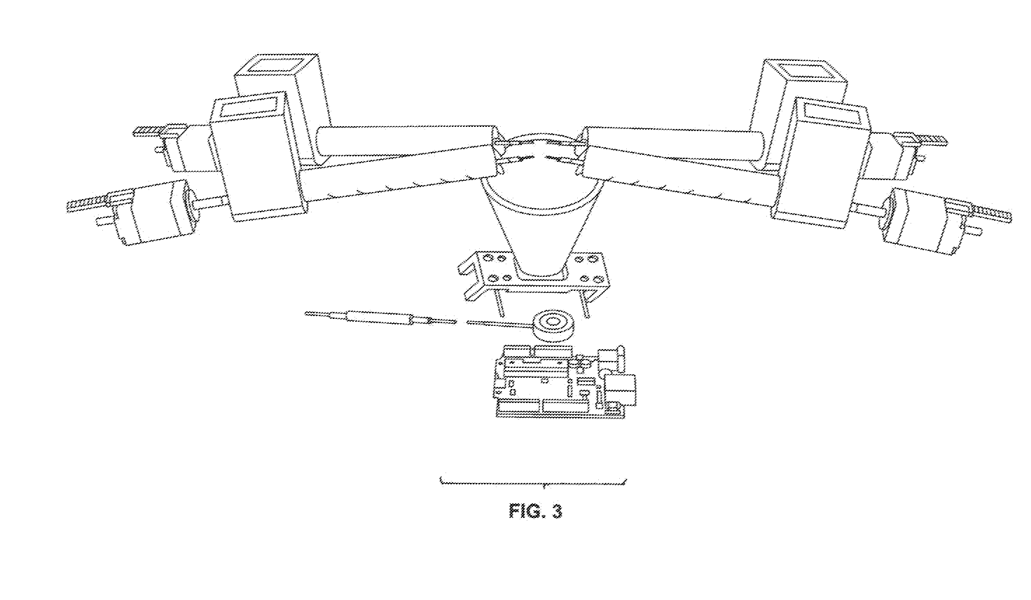

FIG. 3 is a 3D drawing of the main components of the medication dispensing device 10 of the present invention.

Referring to FIGS. 1-3 there is disclosed a medication dispensing device 10 according to an embodiment of the present invention. The device 10 comprises medication tubes 11, dispensing mechanism 12, dose control mechanism including medication counting sensor 13 and weighing scale 14, dispensing cup 15, cup sensor 16, and circuit board 17.

Each medication is stored in its own storage container 11. Each tube 11 may hold up to a 90 day supply of a drug depending on size of the pill, capsule, caplet or gelcap. The device may have the capacity to hold up to ten storage containers 11 and therefore up to ten different medications. The dispensing mechanism 12 is illustrated below: each medication storage container 11 will house an auger/tube 18 and motor assembly 19 that will move the medication from the storage container 11 to a funnel 20. The motors 19 will be connected to and controlled by the circuit board 17, which is programmed to dispense the correct dosage at the correct interval. When medication is dispensed to funnel 20 the medication drops through the medication counting sensor 13, which is connected to the circuit board 17. When a pill dropped is sensed the circuit board 17 in turn stops the motor 19 for that particular storage container 11. If another pill is required for that storage container at that interval then the motor 19 is started again. When all pills are dispensed for that storage container 11 the next motor 19 is started for the next storage container that requires dispensing for that interval.

Additional control mechanism to warrant the right dose is provided and is illustrated below. A load cell 22 which is a weighing sensor 14 connected to the circuit board 17 will weigh the total dispensed weight for the particular dose interval and compare to the appropriate weight for that same dosage interval.

When doses pass controls and are ready for delivery they are routed to a dispensing cup 15. When the dispensing cup 15 is removed the cup sensor 16 will notify the circuit board 17.

As described in the foregoing paragraphs, the circuit board 17 is the brain of the device 10 which controls motors 19, receives input from various sensors 13, 14, 16, send output for alerts, update cloud database, etc.

The device 10 further comprises Bluetooth 23 to send alerts to local devices 33 such as worn pendants. The device further comprises wireless 24 for remote communication, power supply battery backup 25 in case of power outage, removable top 26 to cover storage containers.

The system 1 further comprises remote app 27 and web page 28 which provide means of managing the device 10 and receive alerts and notification from the device 10.

The system 1 will also link to large retail chain pharmacy prescription refill systems to send refill requests automatically. This process will occur in the hosted cloud portion 29 of the application 27 if subscribed to.

The main controller which is the circuit board 17 will store a software program 30 which is the logic of the device 10. This program 30 will control the physical parts of the device 10 including the motors 19 which drive the augers 18 of each storage container 11. The program 30 will store the dosage and dispensing schedule for each storage container 11. The program 30 will also accept input from the various sensors and load cell as well as accept input from the remote app. It will also send alerts and notifications to the remote app 27 as well as local devices 33.

When the program 30 determines based on the stored schedule that it is time for a dose to be dispensed it will send a command to the appropriate motor 19 to start. The motor 19 will turn it's auger 18 slowly until a pill is dropped into a funnel 20.

At the bottom of the funnel 20 is a pill counting sensor 13, which may be a laser array sensor, photo-electric sensor, proximity sensor. When a pill passes through the sensor 13 the circuit board 19 receives the input and sends a command to the motor 19 that is running to stop.

If the program 30 determines that another pill is required from the same storage container 11 for this dose then it will send a command to the same motor 19 to start. Otherwise it will move on to the next storage container 11 from which a pill is required for this dose until all the pills for the particular dose have been dispensed.

If the sensor 13, 14 indicates an incorrect number of pills have been dispensed at any time during the dispensing process the program will stop.

At this point the program 30 will execute a command to “dump” the pills dispensed to that point into an “error” storage bin 31 where they will be manually removed and returned to their respective storage containers. Alerts are also issued to the remote app and local devices 33.

A new dispensing cycle will begin once the dose in error has been “dumped”.

When pills pass through the pill counting sensor they are stored in a temporary holding bin 32 which also has a load cell 22 attached for weighing the dispensed dose.

When the program has completed the dispensing routine for a specific interval it will accept the input from the load cell. If the total weight of the dispensed dose is not equal to the total weight of the prescribed dose the dose will be “dumped” to the error bin 31.

If the total weight of the dispensed dose is equal to the stored total weight of the prescribed dose the dose is transferred to the final dispensing cup 15.

The program 30 will send alerts to the remote app 27 and local devices 33 when the dose is delivered to the final dispensing cup.

When the cup 15 is removed another sensor which is called cup sensor 16 will send output to the program 30 and the program will send an alert to the remote app 27 and local devices 33.

All alert data is also sent to cloud hosted database 29 and remote monitoring system 34. History of alerts, doses, doses in error, pill counts, remaining inventory counts, etc are all sent to the cloud hosted database 29. Inventory counts are kept onboard as well.

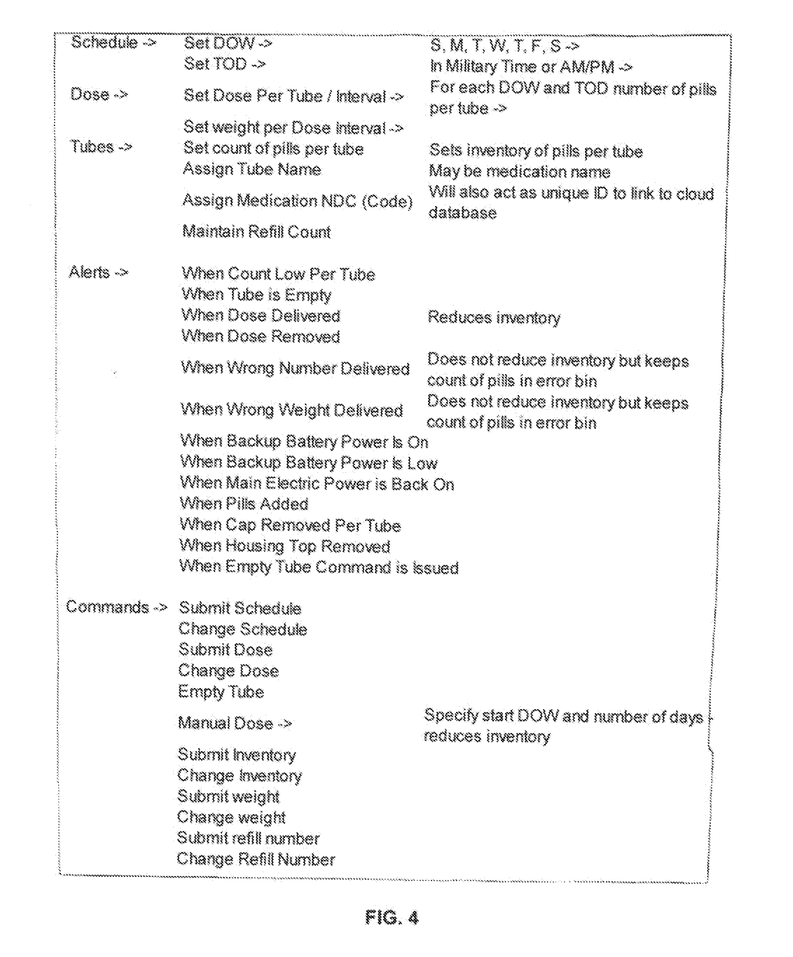

FIG. 4 is a list of features and commands for the remote app 27. The features include scheduling, where the user can and remote caregiver set the day of the week (DOW) out of Sunday, Monday, all the way to Saturday (S, M, T, W, R, F, S) and set today (TOD) in military time or AM/PM. The user can set the dose by the following: set dose per tube/interval and set weight per dose interval. Interval here can be the number of pills dispensed per tube for each DOW and TOD.

The tubes feature allows the user and remote caregiver to set the count of pills per tube (or sets the inventory of pills per tube), assign tube name (which may be the medication name), assign medication NDC (code) which will also act as unique ID to link to cloud database, and maintain refill count.

The alerts feature alerts the user when count is low per tube, when the tube is empty, when doses delivered (this also makes the user aware that the inventory has been reduced), when dose removed, when wrong number delivered (this does not reduce inventory but keeps count of pills), when dose removed, when wrong number delivered (this does not reduce inventory but keeps count of pills in error bin), when wrong weight delivered (this also does not reduce inventory but keeps count of pills in error bin), when backup battery power is on, when backup battery power is low, when main electric power is back on, when pills added, when cap removed per tube, when housing top removed, when empty tube command is issued.

The commands available for the device includes: submit schedule, change schedule, submit dose, change dose, empty tube, manual dose (the user specify the start DOW and number of days—reduces inventory, submit inventory, change inventory, submit weight, change weight, submit refill number, and change refill number.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed.

Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A medication dispensing system, comprising:
a remote app or a web page that allows an end user or a remote caregiver to create and change a dose per medication as well as a schedule for each medication dose, provides alerts and notifications, stores history of doses delivered and doses removed, and submits automatic refill requests when medication approach refill levels; and
a medication dispensing device comprising:
a plurality of medication storage containers each of which configured to store one medication therein;
a dispensing cup;
at least one motor assembly delivering the medication from the storage container;
at least one physical control mechanism to warrant a dose per medication is accurate;
a user interface allowing the end user to create and change a dose per medication as well as a schedule for each medication dose;
a circuit board connected to the motor assembly and physical control mechanism;
wherein the circuit board stores software program which is the logic of the device to control motors, accept input from the physical control mechanism, input from user interface, and input from the remote app or web page.

2. The medication dispensing system of claim 1 further comprising:
cloud hosted database to store end users' information including prescription information, number of refills, filling pharmacy, prescribing doctors;
automatic refill requests integrated with pharmacy system; and
remote monitoring service and in home visiting service by licensed pharmacists.

3. The medication dispensing system of claim 2 wherein the at least one physical control mechanism includes a pill counting sensor to count the pills dispensed by each storage container at each scheduled dose interval and when a pill passes through the sensor the circuit board receives the input and sends a command to the motor that is running to stop.

4. The medication dispensing system of claim 3 wherein the medication dispensing device further comprising a funnel located upstream of the dispensing cup and the medication counting sensor is located at the bottom of the funnel.

5. The medication dispensing system of claim 4 wherein the at least one physical control mechanism includes a load cell to weigh the total dispensed weight for the particular dose interval and compare to the appropriate weight for that same dosage interval.

6. The medication dispensing system of claim 5 wherein the medication dispensing device further comprising a temporary holding bin to temporarily store the medications after the medications pass through the medication counting sensor; the temporary holding bin having the load cell attached to for weighing the dispensed dose.

7. The medication dispensing system of claim 6 wherein the medication dispensing device further comprising a storage error bin for receiving inaccurately dispensed medications.

8. The medication dispensing system of claim 7 wherein the medication dispensing device further comprising a cup sensor which notifies the circuit board when the dispensing cup is removed.

9. The medication dispensing system of claim 8 further comprising battery backup, manual dose dispensing, in home local alert mechanisms including one of worn pendants or wrist bands or table top alarms.

10. The medication dispensing system of claim 9 wherein the medication dispensing device further comprises a plurality of auger tubes each of which is associated with each of the storage containers and which is upstream of the funnel; and Bluetooth and or wireless.

11. The method of remotely and locally controlling and monitoring medication dispensing process comprising:
providing a medication dispensing device which has a plurality of medication storage containers each of which configured to store one medication therein; a dispensing cup; and a plurality of physical control mechanism to warrant the dose is correctly dispensed and sending alerts to the remote app;
providing a remote app or web page that allows an end user or a remote caregiver to create and change a dose per medication as well as a schedule for each medication dose, provides alerts and notifications, stores history of doses delivered and doses removed from the dispensing cup, and submits automatic refill requests when storage containers approach refill levels;
providing cloud hosted database to store end users' information including prescription information, number of refills, filling pharmacy, prescribing doctors;
linking to pharmacy system for automatic refills;
providing remote monitoring service and in home visiting service by licensed pharmacists; and
providing local devices that has alert mechanism.

12. The method of claim 11, wherein the medication dispensing device further has a funnel; at least one motor assembly driving the medication from the storage container to the funnel; a temporary holding bin; a dispensing cup; a user interface that allows an end user to create and change a dose per medication as well as a schedule for each medication dose, a Bluetooth and or wireless; and a circuit board connected to the motor assembly and physical control mechanism; wherein the physical control mechanism includes a medication counting sensor attached to the funnel to warrant a correct number per medication is dispensed, a load cell which is a weight sensor attached to the temporary holding bin to weigh a total weight of a dispensed dose and compare to a total weight of a prescribed dose, a cup sensor to detect the presence of the dispensing cup; and wherein the circuit board stores software program which is the logic of the device to control motors, accept input from the sensors, input from user interface, and input from the remote app or web page.

13. The method of claim 12, further comprising:
creating a prescription including a dose per medication as well as a schedule for each medication dose;
determining it is time for a dose to be dispensed based on the stored schedule and sending a command to the appropriate motor to start;
delivering a pill from a storage container to the funnel where the pill passes through the medication counting sensor which sends input to the circuit board that sends a “stop” command to the motor;
moving on to the next storage container if the program determines that only one piece of pill is required from the same storage container;
storing the pill passed through the pill counting sensor in a temporary holding bin if the medication counting sensor indicates a correct number of pill(s) has been dispensed;
transferring the dispensed dose to the final dispensing cup if the total weight of the dispensed dose is equal to the total weight of the prescribed dose;
sending an alert to the remote app and local devices if the cup sensor detects the dispensing cup is removed; and
sending all alert data to cloud hosted database and remote monitoring system.

14. The method of claim 13, further comprising sending a command to the same motor to start if the program determines that another piece of pill is required from the same storage container for this dose.

15. The method of claim 14, further comprising stopping the dispensing process and dumping the pills dispensed into an error storage bin and sending alerts to the remote app and local devices if the sensor indicates an incorrect number of pills have been dispensed at any time during the dispensing process.

16. The method of claim 15, further comprising dumping the dispensed dose to the error storage bin and sending alerts to the remote app and local devices if the total weight of the dispensed dose is not equal to the total weight of the prescribed dose.

17. The method of claim 16, further comprising starting a new dispensing process once the dose in error has been dumped.

18. The method of claim 17, wherein the local alert mechanism includes one of a pendant, a wrist band, a table top alarm that receives alert from the medication dispensing device or remote app.
